(19) United States
(12) Patent Application Publication
(10) Pub. No.: US 2026/0147127 A1
(43) Pub. Date: May 28, 2026

(54) Corner Guide, Detector Having a Corner Guide, and Method of Using a Corner Guide

(71) Applicant: Varex Imaging Corporation, Salt Lake City, UT (US)

(72) Inventors: Robert Spratt, Salt Lake City, UT (US); Xiaoyang Shen, Salt Lake City, UT (US)

(21) Appl. No.: 18/962,956

(22) Filed: Nov. 27, 2024

(51) Int. Cl. G01T 7/00

(52) U.S. Cl. CPC G01T 7/00

(57) ABSTRACT

A corner guide is disclosed. The corner guide has a base, a slider, and a fastener. The base includes a base body, a through-hole through the base body, and a base surface. The through-hole defined through the base body intersects the base surface. The slider includes a slider body, a through-hole defined through the slider body, and a slider surface. The through-hole through the slider body intersects the slider surface. The slider surface corresponds with the base surface. The fastener is configured to connect the base and the slider via the through-hole defined through the base body and the through-hole defined through the slider body. The slider surface is configured to move along and slide apart from the slider surface when the fastener secures the slider to the base.

### BACKGROUND

Digital imaging systems, such as digital X-ray detectors or digital radiographic devices, are conventionally used for X-ray inspection of an object that immediately produces a digital image on a computer screen. Often, digital radiography (DR) uses X-ray-sensitive plates or a digital detector array to obtain details of the object as it is being imaged.

Construction of digital X-ray detectors typically requires specific qualifications for the detector housing and related components in part to protect fragile internal components of the digital X-ray detector that can be highly susceptible to damage by physical impact or shock. Some digital X-ray detectors include a relatively stiff enclosure, which rigidly attaches to the internal components. However, as digital X-ray imaging systems have become increasingly widespread, digital X-ray detectors have become more portable for even greater versatility, but therefore also need to be further protected from inadvertent drops from higher heights without adding more weight to the detector.

### OVERVIEW

Disclosed herein is a corner guide for a detector, detectors having the corner guide, and a method of using the corner guide. In one or more embodiment, the corner guide expands to secure glass and baseplate assemblies in a radiographic detector.

In one or more embodiment, in a detector, one corner of a module makes contact with a housing body, but the other corners of the module require clearance for internal components which cannot contact a housing wall. If an impact occurs that causes the module to flex into the clearance corner, supporting standoffs may break. The corner guides described herein allow for clearance in the module, allow for improved assembly, and create rigid contact between the module and the housing wall.

One or more aspects of the disclosure provide a corner guide having a base. The base includes a base body, a through-hole defined through the base body, and a base surface. The through-hole defined through the base body intersects the base surface. The corner guide also includes a slider. The slider includes a slider body, a through-hole defined through the slider body, and a slider surface. The through-hole defined through the slider body intersects the slider surface. The slider surface corresponds with the base surface. The corner guide also includes a fastener configured to connect the base and the slider via the through-hole defined through the base body and the through-hole defined through the slider body. The slider surface is configured to move along and slide apart from the base surface when the fastener secures the slider to the base.

One or more aspects of the disclosure provide a detector having a housing assembly. The detector also has a sensor array configured to be received in the housing assembly. The detector also includes a corner abutting the sensor array. The detector also includes a corner guide having a base. The base includes a base body, a through-hole defined through the base body, and a base surface. The through-hole defined through the base body intersects the base surface. The corner guide also includes a slider. The slider includes a slider body, a through-hole defined through the slider body, and a slider surface. The through-hole defined through the slider body intersects the slider surface. The slider surface corresponds with the base surface. The corner guide also includes a fastener that connects the base and the slider via the through-hole defined through the base body and the through-hole defined through the slider body. The slider surface is configured to move along and slide apart from the base surface when the fastener secures the slider to the base. The slider of the corner guide secures the sensor array against the corner abutting the sensor array of the housing assembly.

One or more aspects of the disclosure provide a method of securing a sensor array in a detector. The method includes abutting the sensor array against a corner in a housing assembly of the detector. The method also includes securing a base of a corner guide to the housing assembly of the detector. The corner guide has a base. The base includes a base body, a through-hole defined through the base body, and a base surface. The through-hole defined through the base body intersects the base surface. The corner guide also includes a slider. The slider includes a slider body, a through-hole defined through the slider body, and a slider surface. The through-hole defined through the slider body intersects the slider surface. The slider surface corresponds with the base surface. The corner guide also includes a fastener that connects the base and the slider via the through-hole defined through the base body and the through-hole defined through the slider body. The method further includes tightening the fastener of the corner guide such that (i) the slider surface of the slider moves along and slide apart from the base surface of the base when the fastener secures the slider to the base, and (ii) the slider secures the sensor array against the corner in the housing assembly.

Other embodiments will become apparent to those of ordinary skill in the art by reading the following detailed description, with reference where appropriate to the accompanying drawings.

### BRIEF DESCRIPTION OF THE DRAWINGS

Example embodiments are described herein with reference to the drawings.

FIG. 1 is an exploded view of a corner guide, according to an example embodiment.

FIG. 2 is an exploded view of another corner guide, according to an example embodiment.

FIG. 3A is a perspective view of the corner guide of FIG. 1.

FIG. 3B is an additional perspective view of the corner guide of FIG. 1.

FIG. 3C is a top view of the corner guide of FIG. 1.

FIG. 3D is a bottom view of the corner guide of FIG. 1.

FIG. 3E is a perspective view of a base of the corner guide of FIG. 1.

FIG. 3F is a perspective view of a slider of the corner guide of FIG. 1.

FIG. 4A is an exploded view of a detector and a corner guide of FIG. 1, according to an example embodiment.

FIG. 4B is a perspective view of a portion of the detector of FIG. 4A and the corner guide FIG. 1.

FIG. 4C is a top view of the detector of FIG. 4A.

FIG. 5 is a block diagram of a method of securing a sensor array in a detector, according to an example embodiment.

### DETAILED DESCRIPTION

This description describes several example embodiments, at least one or more of which pertain to corner guides for detectors. The corner guides described herein may be adjustably-positioned within a detector in order to secure internal components of the detector in the event of a sudden impact, such as a drop.

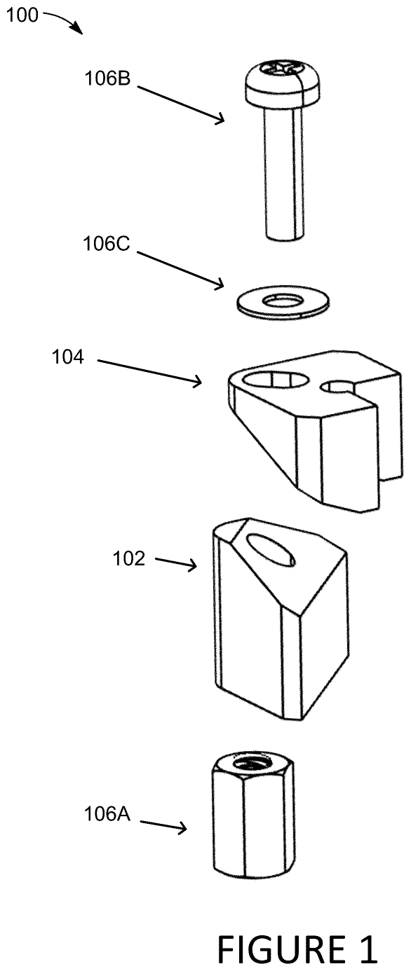

FIG. 1 is an exploded view of an example corner guide 100. The corner guide 100 includes a base 102, a slider 104, and a fastener 106 that includes a nut 106A, a screw 106B, and a washer 106C. Other fasteners are also possible, such as a bolt, a rivet, a nail, and an anchor.

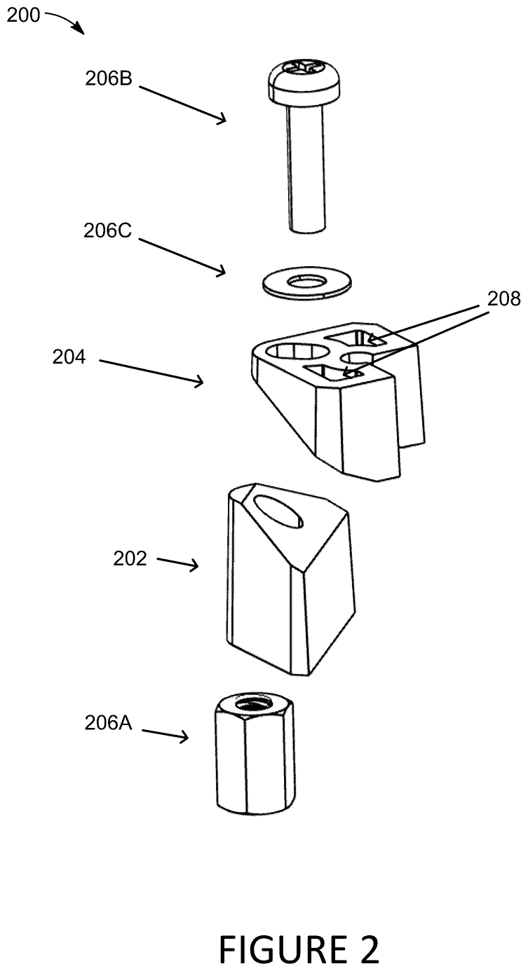

FIG. 2 is an exploded view of another example corner guide 200 having a slider 204 including one or more openings 208. The corner guide 200 includes a base 202, the slider 204, and a fastener 206 that includes a nut 206A, a screw 206B, and a washer 206C. The base 202 and the fastener 206 may take the same or similar form as the base 102 and the fastener 106, respectively. The one or more openings 208 may be created during the molding process of the slider 204.

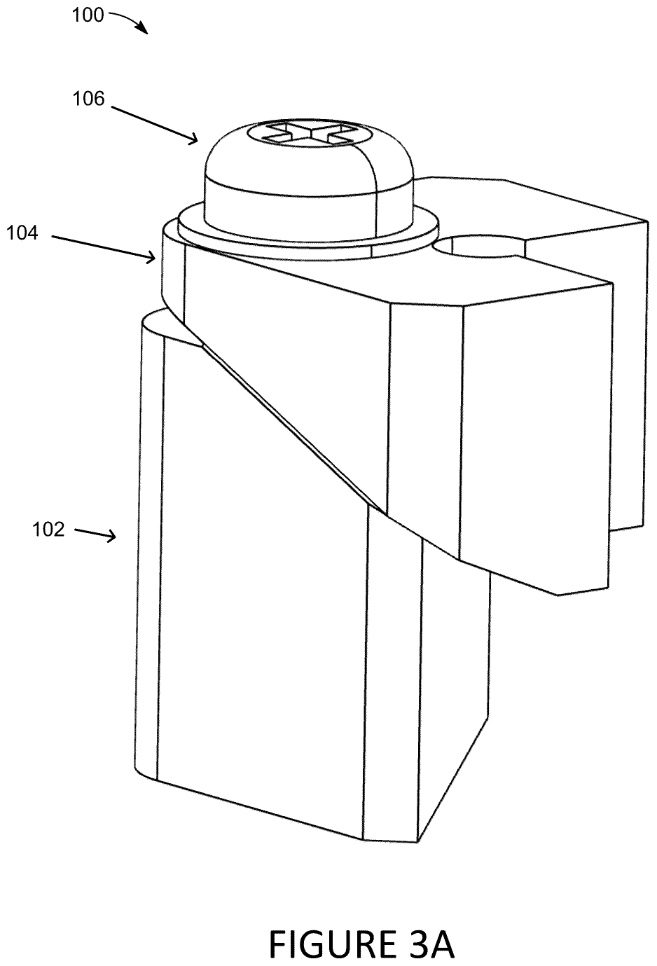

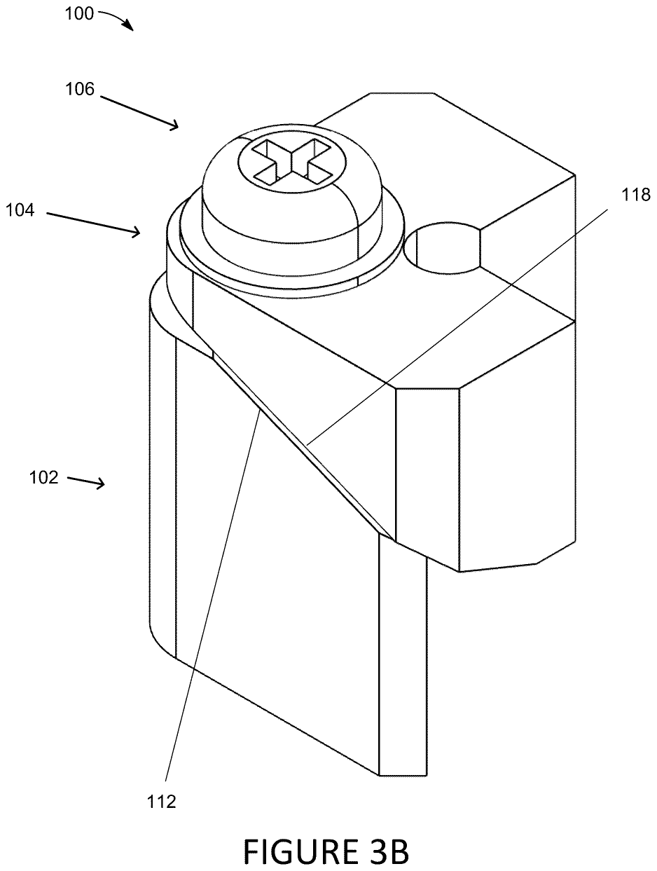

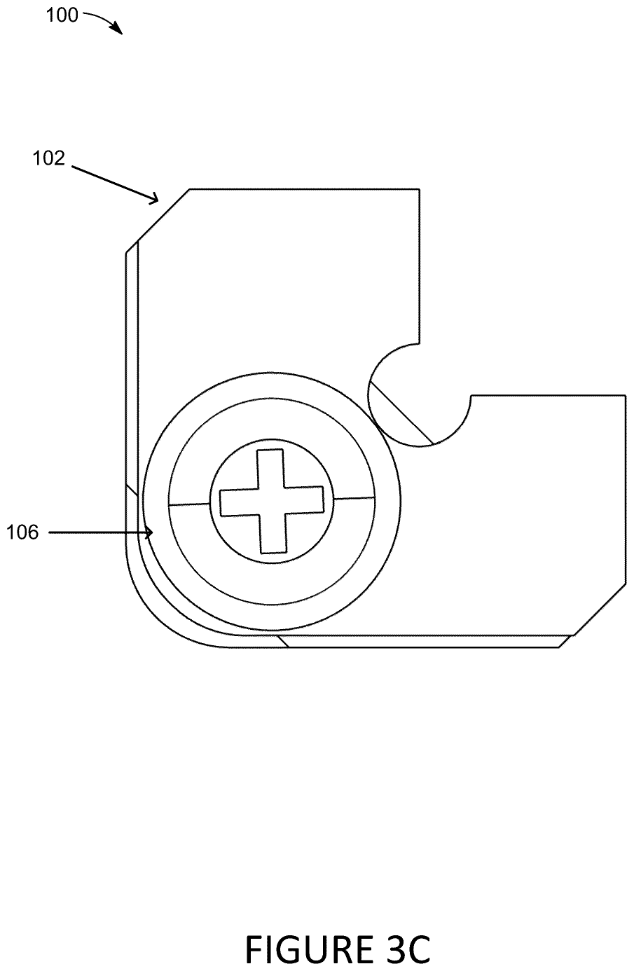

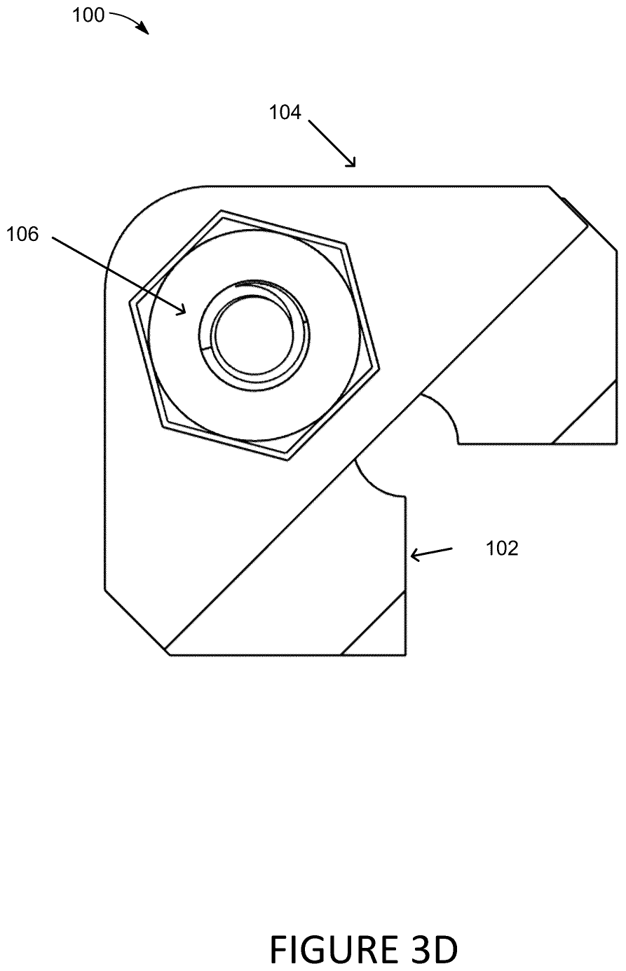

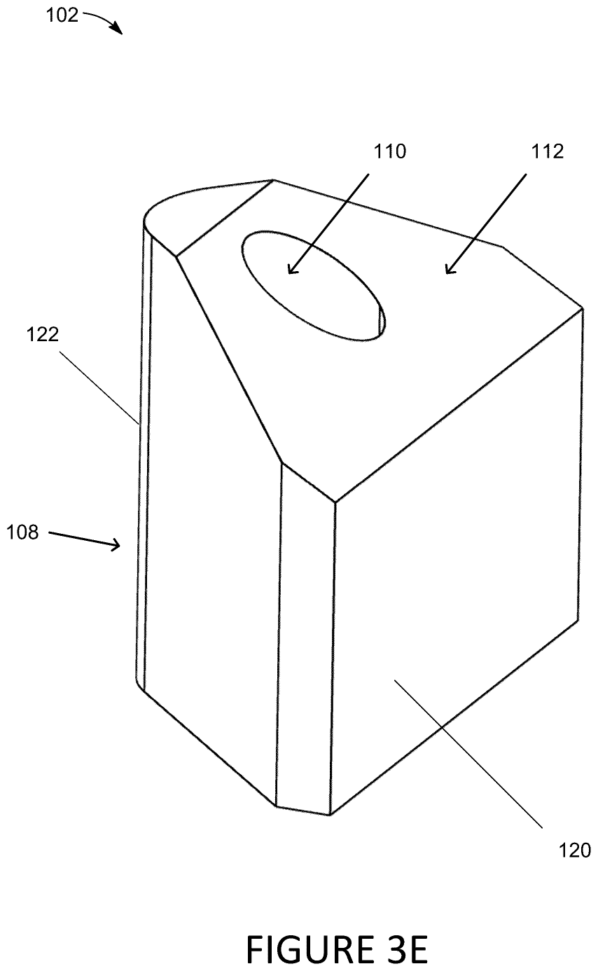

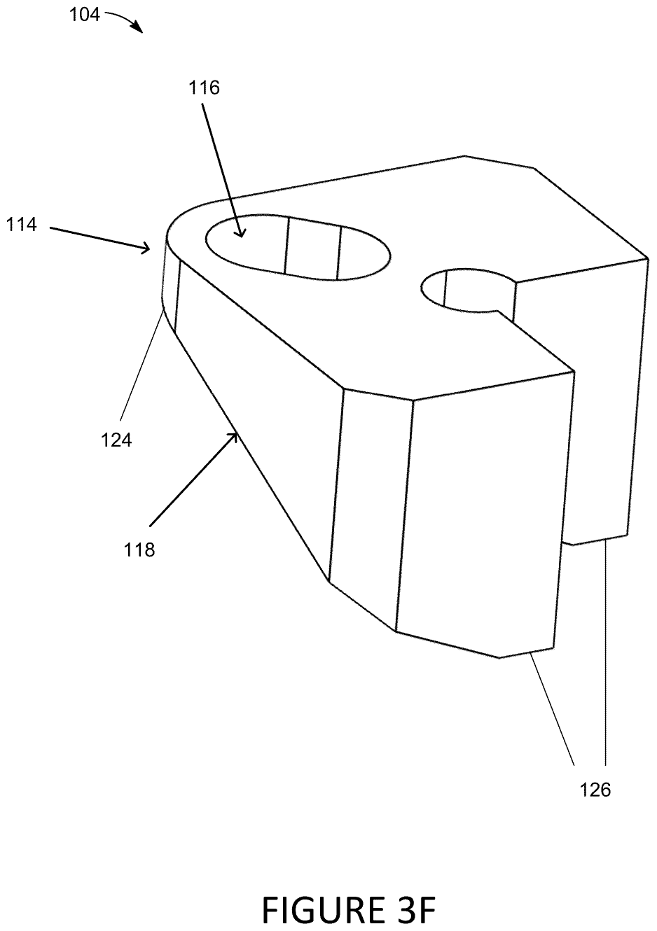

FIGS. 3A-3D depict various views of the corner guide 100. FIGS. 3A and 3B depict perspective views of the corner guide 100, FIG. 3C depicts a top view of the corner guide 100, and FIG. 3D depicts a bottom view of the corner guide 100. FIG. 3E depicts the base 102 of the corner guide 100, and FIG. 3F depicts the slider 104 of the corner guide 100.

The corner guide 100 includes the base 102. The base includes a base body 108, a through-hole 110 defined through the base body 108, and a base surface 112 (as best shown in FIG. 3E). The through-hole 110 defined through the base body 108 intersects the base surface 112. In one or all embodiments, the through-hole 110 is oblong in shape. Further, in one or all embodiments, the base 102 includes a flat vertical wall 120 that is configured to be positioned opposite an exterior edge 122 of the base 102. In various such embodiments, the base surface 112 slopes down from a first height near the exterior edge 122 of the base 102 to a second height near the flat vertical wall 120 of the base 102, and the first height is greater than the second height. In one or all embodiments, the second height near the flat vertical wall 120 of the base is selected to accommodate a portion of a fastener 106, as well as provide the appropriate height for the slider 104 to contact a component of a detector into which the corner guide 100 is to be inserted. Further, in one or all embodiments, a flat platform piece near the exterior edge 122 of the base 102 exists, and the base surface 112 slopes down from the flat platform piece towards the flat vertical wall 120.

The corner guide 100 also includes the slider 104. The slider includes a slider body 114, a through-hole 116 defined through the slider body 114, and a slider surface 118 (as best shown in FIG. 3F). The through-hole 116 defined through the slider body 114 intersects the slider surface 118. In one or all embodiments, the through-hole 116 is oblong in shape. Further, in one or all embodiments, the slider 104 has a c-shaped profile. In various such embodiments, the slider surface 118 slopes up from a first height near a center 124 of the c-shaped profile of the slider to a second height near edges 126 of the c-shaped profile of the slider, and the first height is smaller than the second height. In various such embodiments, the c-shaped profile of the slider 104 reduces stress concentrations in the slider 104, and therefore reduces sharp corners abutting any other component of a detector into which the corner guide 100 is inserted. Further, in one or more embodiment, the slider 104 includes a rigid plastic. In one or more embodiment, the slider 104 includes a flexible rubber.

In one or all embodiments, the base 102 and the slider 104 are formed independently. As such, sliding between the base 102 and the slider 104 is possible, as the components are moveable with respect to each other.

In one or all embodiments, the slider surface 118 corresponds with the base surface 112. Further, in one or all embodiments, the base surface 112 is ramped at a predetermined degree of incline, and the slider surface 118 is ramped at the predetermined degree of incline (as best shown in FIG. 3B). Further, in one or all embodiments, the predetermined degree of incline is between 30 degrees and 60 degrees.

The corner guide 100 also includes the fastener 106 that connects the base 102 and the slider 104 via the through-hole 110 through the base body 114 and the through-hole 116 through the slider body 114. In one or all embodiments, the fastener 106 includes a nut, a screw, and an optional washer. Further, in one or all embodiments, the slider surface 118 is configured to move along and slide apart from the base surface 112 when fastening the slider 104 to the base 102. In various such embodiments, the base 102 is fixed relative to the detector into which the corner guide 100 is inserted, and only the slider 104 moves as the fastener secures the slider 104 to the base 102 of the corner guide 100.

For example, in use, the corner guide 100 works by positioning the base 102 of the corner guide 100 adjacent a desired component of a detector. The slider 104 interacts with the base 102 via the slider surface 118 and the base surface 112. As the fastener 106 is tightened, the slider surface 118 of the slider 104 is shifted further down the base surface 112 of the base 102. The oblong through-holes 110 and 116, respectively, each allow movement between the slider 104 and the base 102 as the fastener 106 tightens the slider 104 to the base 102. The further the fastener 106 is tightened, the further the slider surface 118 of the slider 104 moves along the base surface 112 of the base 102, which causes the slider 104 to take up more space towards an internal direction of the detector. In one or all embodiments, tightening of the fastener 106 continues until the slider surface 102 contacts the component of the detector and secures it to an opposing portion of the detector.

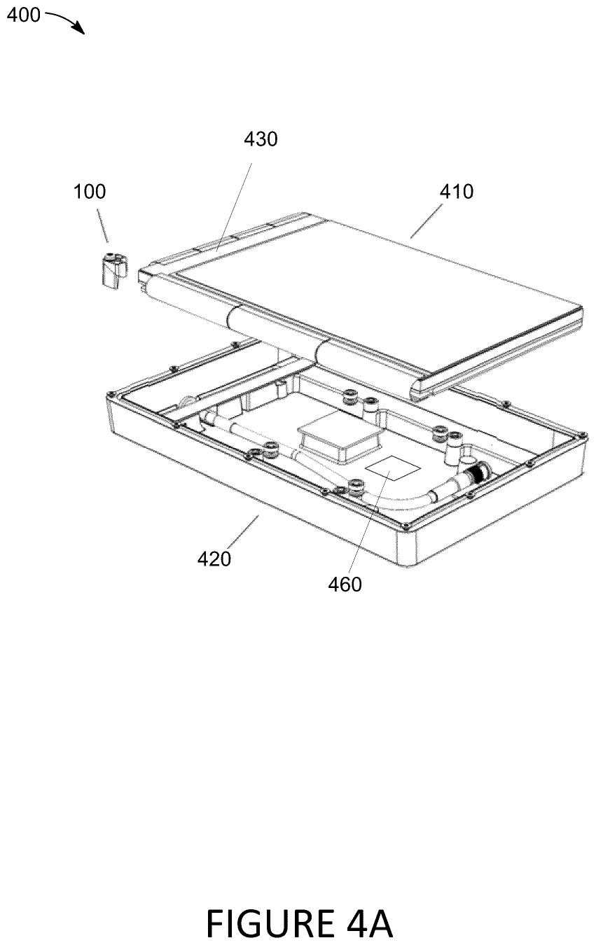

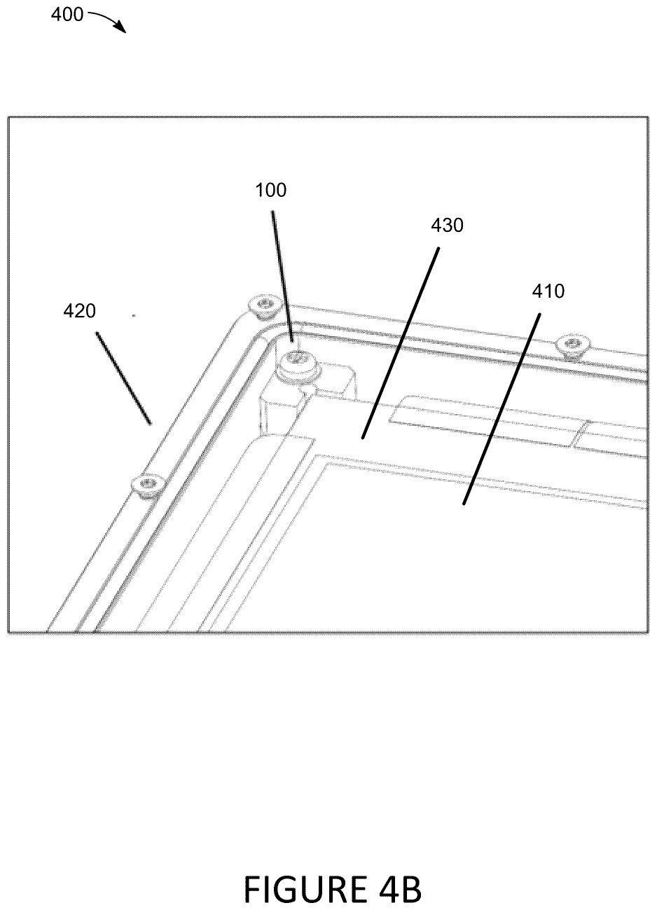

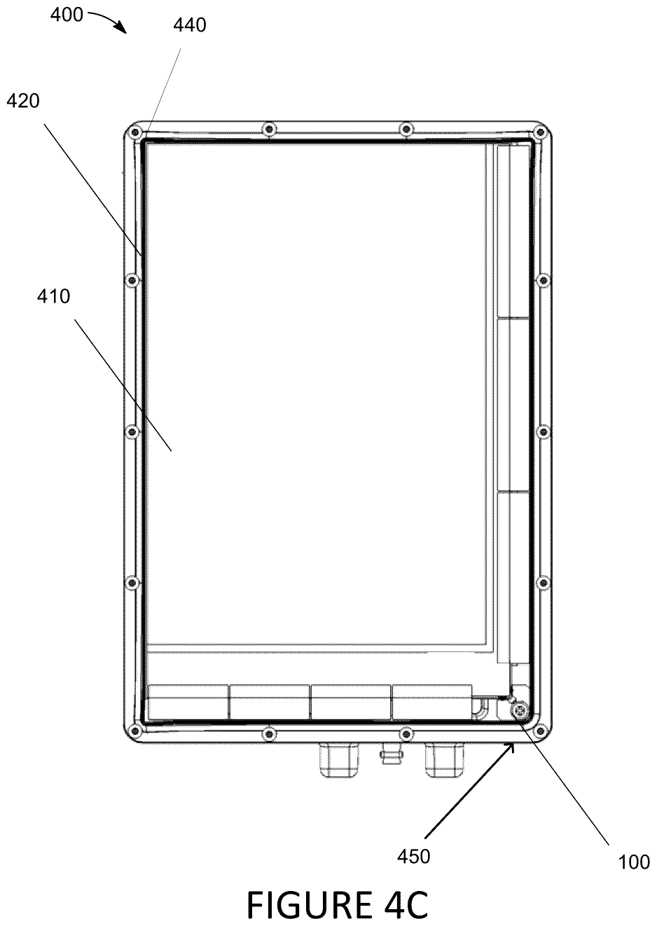

FIGS. 4A-4C depict a detector 400, according to an example embodiment. In one or all embodiments, the detector 400 is an X-ray detector or a radiographic detector. In one or all embodiments, the detector 400 includes a housing assembly 420 and a baseplate assembly 410 configured to be received in the housing assembly 420. In one or all embodiments, the housing assembly is a plastic housing configured to receive the baseplate assembly 410.

In various such embodiments, the baseplate assembly 410 further includes a sensor array 430. In one or all embodiments, the sensor array 430 is a glass, two-dimensional sensor array. In various such embodiments, the sensor array 430 and the baseplate assembly 410 are disposed within the plastic housing. The sensor array 430 is configured to generate image data in response to incident X-rays. In one or all embodiments, the sensor array 430 includes sensors such as direct conversion sensors, indirect conversion sensor, an amorphous silicon (a-Si) based imaging array a complementary metal oxide semiconductors (CMOS) based imaging array, or a photon counting imaging array. The sensor array 430 may include a scintillator or X-ray conversion materials such as gadolinium oxysulfide (Gd202S; GOS; Gadox), gadolinium oxysulfide doped with terbium (Gd₂0₂S: Tb), cesium iodide (Csl), or the like. The direct conversion sensor may include X-ray conversion materials and/or semi conducting materials such as cadmium telluride (CdTe). In one or all embodiments, the sensor array 430 includes electronic circuits such as readout circuits, communication circuits, or processing circuits.

In various such embodiments, the housing assembly 420 of the detector 400 is a structure formed from a material such as impact-resistant plastic, non-impact resistant plastic, polycarbonate, or acrylic. Plastic includes a wide range of synthetic or semi-synthetic materials that use polymers as a main ingredient. In various such embodiments, the housing assembly 420 includes a platform and a plurality of side walls. The housing assembly 420 is configured to support various other components such as the baseplate assembly 410, including the sensor array 430, antennas, batteries, or the like. These and/or other components may be part of the detector 400.

Further, in one or all embodiments, the use of plastic for the housing assembly 420 rather than a metal decreases a weight of the detector 400. In one or all embodiments, the detector 400 is a mobile device, such as a portable flat panel detector. The detector 400 may be moved from location to location, inserted into a bucky, or otherwise manipulated by a user. The reduced weight of the detector may reduce a strain on a user carrying the detector.

In one or all embodiments, the housing assembly 420 includes structural features 460 such as ribs, depressions, grooves, or posts to provide rigid or semi-rigid support to the other components of the detector 400. In one or all embodiments, the housing assembly 400 is formed via molding, welding, or gluing various components.

In one or all embodiments, the sensor array 430 of the baseplate assembly 410 is supported within the housing assembly 420. For example, standoffs, or structures of the housing assembly 420 support the sensor array 430 and the baseplate assembly 410 within the housing assembly 420.

The baseplate assembly 410 is connected to the housing assembly 420 such that the baseplate assembly 410 and the housing assembly 420 form an enclosure surrounding the sensor array 430 of the baseplate assembly 410. In one or more embodiment, the enclosure of the detector 400 is completely sealed once the baseplate assembly 410 is received in and attached to the housing assembly 420. In one or more embodiment, other structure, such as screws with seals, electrical connectors or contacts, over-center cams, plastic hinges, cantilever snaps, hinge and pin connections, or pressure sensitive adhesive are used to seal the enclosure surrounding the sensor 430 of the baseplate assembly 410.

In order to protect the sensor array 430 from a drop, a corner 440 abuts the sensor array 430 of the detector 400. In order to secure the sensor array 430 against the corner 440 while maintaining enough freedom of movement for the sensor array 430 in the event of a drop, the corner guide 100 is positioned at an opposing corner 450 of the detector 400.

In one or all embodiments, the corner guide 100 pushes the sensory array 430 into the corner 440 and fills the available space in the area of the opposing corner 450 of the detector 400. In one or all embodiments, the corner guide position creates a rigid fit between the sensor array 430 and the housing assembly 420. In various such embodiments, the rigid fit reduces or prevents damage to the sensor array 430 from drop impacts. Thus, in various embodiments, the corner guide 100 provides lateral fixation of the sensor array 430 in the detector 400, while being easily installed and expanding to fill space in the detector 400 by tightening the fastener 106 of the corner guide 100. Further, in one or all embodiments, the base of the corner guide 100 is affixed to the housing assembly 420, which further integrates the corner guide 100 into the detector 400.

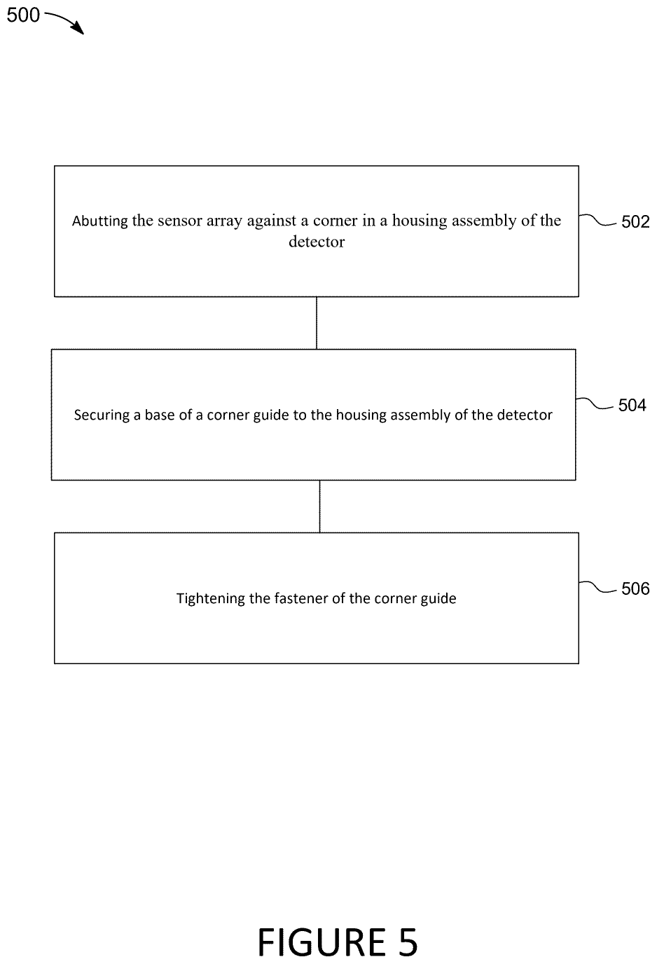

FIG. 5 is a block diagram of a method 500 for securing a sensor array in a detector. As shown in FIG. 5, the method 500 includes one or more operations, functions, or actions as illustrated by blocks 502, 504, and 506. Any blocks may be performed in parallel, and/or in a different order than those described herein. Also, the various blocks may be combined into fewer blocks, divided into additional blocks, and/or removed based upon the desired implementation.

At block 502, the method 500 includes abutting the sensor array against a corner in a housing assembly of the detector.

At block 504, the method 500 includes securing a base of a corner guide to the housing assembly of the detector. The corner guide has a base. The base includes a base body, a through-hole defined through the base body, and a base surface. The through-hole defined through the base body intersects the base surface. The corner guide also includes a slider. The slider includes a slider body, a through-hole defined through the slider body, and a slider surface. The through-hole defined through the slider body intersects the slider surface. The slider surface corresponds with the base surface. The corner guide also includes a fastener that connects the base and the slider via the through-hole defined through the base body and the through-hole through the slider body.

At block 506, the method 500 includes tightening the fastener of the corner guide such that the slider surface of the slider is configured to move along and slide apart from the base surface of the base when the fastener secures the slider to the base, and that the slider secures the sensor array against the corner in the housing assembly.

In one or all embodiments, tightening the fastener of the corner guide includes forcing the slider to move along the base until the slider of the corner guide secures the sensor array against the corner abutting the sensor array of the housing assembly.

It should be understood that the arrangements described herein and/or shown in the drawings are for purposes of example only and are not intended to be limiting. As such, those skilled in the art will appreciate that other arrangements and elements (e.g., machines, interfaces, functions, orders, and/or groupings of functions) can be used instead, and one or more elements can be omitted altogether.

While various aspects and embodiments are described herein, other aspects and embodiments will be apparent to those skilled in the art. The various aspects and embodiments disclosed herein are for purposes of illustration and are not intended to be limiting, with the true scope being indicated by the claims, along with the full scope of equivalents to which such claims are entitled. It is also to be understood that the terminology used herein for the purpose of describing embodiments only, and is not intended to be limiting.

In this description, the articles “a,” “an,” and “the” are used to introduce elements and/or functions of the example embodiments. The intent of using those articles is that there is one or more of the introduced elements and/or functions.

In this description, the intent of using the term “and/or” within a list of at least two elements or functions and the intent of using the terms “at least one of,” “at least one of the following,” “one or more of,” “one or more from among,” and “one or more of the following” immediately preceding a list of at least two components or functions is to cover each embodiment including a listed component or function independently and each embodiment including a combination of the listed components or functions. For example, an embodiment described as including A, B, and/or C, or at least one of A, B, and C, or at least one of: A, B, and C, or at least one of A, B, or C, or at least one of: A, B, or C, or one or more of A, B, and C, or one or more of: A, B, and C, or one or more of A, B, or C, or one or more of: A, B, or C is intended to cover each of the following possible embodiments: (i) an embodiment including A, but not B and not C, (ii) an embodiment including B, but not A and not C, (iii) an embodiment including C, but not A and not B, (iv) an embodiment including A and B, but not C, (v) an embodiment including A and C, but not B, (v) an embodiment including B and C, but not A, and/or (vi) an embodiment including A, B, and C. For the embodiments including component or function A, the embodiments can include one A or multiple A. For the embodiments including component or function B, the embodiments can include one B or multiple B. For the embodiments including component or function C, the embodiments can include one C or multiple C. In accordance with the aforementioned example and at least one or more of the example embodiments, “A” can represent a component, “B” can represent a system, and “C” can represent a system.

The use of ordinal numbers such as “first,” “second,” “third” and so on is to distinguish respective elements rather than to denote an order of those elements unless the context of using those terms explicitly indicates otherwise. Further, the description of a “first” element, such as a first plate, does not necessitate the presence of a second or any other element, such as a second plate.

What is claimed is:

1. A corner guide comprising:
a base, wherein the base comprises:
a base body,
a through-hole defined through the base body, and
a base surface, wherein the through-hole defined through the base body intersects the base surface;
a slider, wherein the slider comprises:
a slider body,
a through-hole defined through the slider body, and
a slider surface, wherein the through-hole defined through the slider body intersects the slider surface, and wherein the slider surface corresponds with the base surface; and
a fastener configured to connect the base and the slider via the through-hole defined through the base body and the through-hole defined through the slider body, wherein the slider surface is configured to move along and slide apart from the base surface when the fastener secures the slider to the base.

2. The corner guide of claim 1, wherein the through-hole defined through the base body is oblong, and wherein the through-hole defined through the slider body is oblong.

3. The corner guide of claim 1, wherein the base comprises a flat vertical wall that is configured to be positioned opposite an exterior edge of the base.

4. The corner guide of claim 3, wherein the base surface slopes down from a first height near the exterior edge of the base to a second height near the flat vertical wall of the base, and wherein the first height is greater than the second height.

5. The corner guide of claim 1, wherein the slider has a c-shaped profile.

6. The corner guide of claim 5, wherein the slider surface slopes up from a first height near a center of the c-shaped profile of the slider to a second height near edges of the c-shaped profile of the slider, and wherein the first height is smaller than the second height.

7. The corner guide of claim 1, wherein the base surface is ramped at a predetermined degree of incline, and wherein the slider surface is also ramped at the predetermined degree of incline.

8. The corner guide of claim 7, wherein the predetermined degree of incline is between 30 degrees and 60 degrees.

9. The corner guide of claim 1, wherein the base and the slider are formed independently.

10. The corner guide of claim 1, wherein the fastener comprises a nut and a screw.

11. The corner guide of claim 1, wherein the slider comprises a rigid plastic.

12. The corner guide of claim 1, wherein the slider comprises a flexible rubber.

13. A detector comprising:
a housing assembly;
a sensor array configured to be received in the housing assembly;
a corner abutting the sensor array; and
a corner guide comprising:
a base, wherein the base comprises:
a base body,
a through-hole defined through the base body, and
a base surface, wherein the through-hole defined through the base body intersects the base surface;
a slider, wherein the slider comprises:
a slider body,
a through-hole defined through the slider body, and
a slider surface, wherein the through-hole defined through the slider body intersects the slider surface, and wherein the slider surface corresponds with the base surface; and
a fastener that connects the base and the slider via the defined through-hole through the base body and the through-hole defined through the slider body, wherein the slider surface is configured to move along and slide apart from the base surface when the fastener secures the slider to the base,
wherein the slider of the corner guide secures the sensor array against the corner abutting the sensor array in the housing assembly.

14. The detector of claim 13, wherein the through-hole through the base body is oblong, and wherein the through-hole through the slider body is oblong.

15. The detector of claim 13, wherein the base surface is ramped at a predetermined degree of incline, and wherein the slider surface is also ramped at the predetermined degree of incline.

16. The detector of claim 15, wherein the predetermined degree of incline is between 30degrees and 60 degrees.

17. The detector of claim 13, wherein the fastener comprises a nut and a screw.

18. The detector of claim 13, wherein the base of the corner guide is affixed to the housing assembly.

19. A method of securing a sensor array in a detector, the method comprising:
abutting the sensor array against a corner in a housing assembly of the detector;
securing a base of a corner guide to the housing assembly of the detector, the corner guide comprising:
the base, wherein the base comprises:
a base body,
a through-hole defined through the base body, and
a base surface, wherein the through-hole defined through the base body intersects the base surface;
a slider, wherein the slider comprises:
a slider body,
a through-hole defined through the slider body, and
a slider surface, wherein the through-hole defined through the slider body intersects the slider surface, and wherein the slider surface corresponds with the base surface; and
a fastener that connects the base and the slider via the through-hole defined through the base body and the through-hole defined through the slider body; and
tightening the fastener of the corner guide such that (i) the slider surface of the slider moves along and slide apart from the base surface of the base when the fastener secures the slider to the base, and (ii) the slider secures the sensor array against the corner in the housing assembly.

20. The method of claim 19, wherein tightening the fastener of the corner guide comprises forcing the slider to move along the base until the slider of the corner guide secures the sensor array against the corner abutting the sensor array in the housing assembly.
